(19) United States
(12) Patent Application Publication
(10) Pub. No.: US 2013/0283625 A1
(43) Pub. Date: Oct. 31, 2013

(54) Level Clip for Wall-Mounted Posters

(71) Applicant: Scott Sullivan, San Francisco, CA (US)

(72) Inventor: Scott Sullivan, San Francisco, CA (US)

(21) Appl. No.: 13/874,350

(22) Filed: Apr. 30, 2013

Related U.S. Application Data
(60) Provisional application No. 61/687,685, filed on Apr. 30, 2012.

(51) Int. Cl. G01C 9/28

(52) U.S. Cl. CPC G01C 9/28
USPC 33/371

(57) ABSTRACT

A level clip is disclosed for securing along the edge of a wall-hanging substrate for the purpose of leveling the substrate. The clip includes a body having a substrate-receiving slot and a contact surface. The clip also supports a bubble level so that it is aligned with the contact surface. The user inserts the edge of the substrate into the slot so that the edge of the substrate abuts evenly with the contact surface, thereby allowing the bubble level to convey level-alignment information in response to rotational movement of the substrate. Resilient outer arms adjacent to the slot create friction to help hold the clip in place.

### CROSS-REFERENCE TO RELATED APPLICATION

This application claims the benefit of U.S. Provisional Application No. 61/687,685, filed Apr. 30, 2012, entitled “Level Clip”.

### BACKGROUND OF THE INVENTION

1) Field of the Invention The present invention generally relates to bubble levels, and more particularly, to improvements to such levels.

2) Discussion of Related Art

There are many different types of leveling devices. A commonly used one is called a bubble level. Once such bubble level uses a small cylindrical vial having an accurately curved side wall along the longitudinal axis. The vial is less-than 100% filled with a colored semi-viscous fluid (usually an oil) which defines an air bubble (hence the name “bubble” level). In use, as the vial is tilted, the bubble will diligently and continuously move to the highest point against the curved wall. Marks located on the walls of the vial help the user determine the relative location of the bubble within the vial, i.e., when the vial is “level”. These vials are typically mounted within a frame structure to increase the sensitivity and usability of the level.

Even though vials are secured within a variety of frame shapes and sizes, these bubble levels are somewhat limited in use. For example, they cannot easily or effectively be used to level thin materials, such as paper templates, posters or thin painter's boards being mounted against a wall. When mounting a poster against the wall, the user cannot easily use a conventional bubble level (sometimes called a “Carpenter's level”) because the level must be held carefully against a very thin paper edge. This proves to be a very awkward process because the thin paper edge does not provide sufficient contact against the level frame. The level also requires the user to hold it and therefore leaves only one other hand to hold the poster and leaves no free hands to secure the level poster to the wall using a tack or tape. There is just too much room for inaccuracies, frustration, and mistakes.

It is a first object of the present invention to overcome the deficiencies of the prior art.

It is another object of the present invention to provide a bubble level that can be secured along the edge of paper or relatively thin materials for the purpose of aiding in hanging the paper or other level against a wall.

### SUMMARY OF THE INVENTION

A level clip is disclosed for securing along the edge of a wall-hanging substrate for the purpose of leveling the substrate (helping to easily hang a poster, picture frame or painter's board level against a wall). The clip includes a body having a substrate-receiving slot and a contact surface. The clip also supports a bubble level so that it is aligned with the contact surface. The user inserts the edge of the substrate into the slot so that the edge of the substrate abuts evenly with the contact surface, thereby allowing the bubble level to convey level-alignment information in response to rotational movement of the substrate. Resilient outer arms adjacent to the slot create friction to help hold the clip in place.

### BRIEF DESCRIPTION OF THE DRAWINGS

The invention can be more fully understood from the following detailed description taken in conjunction with the accompanying drawings, in which:

FIG. 1 is a perspective view of a level clip, according to the present invention including a frame structure and a bubble vial;

FIG. 2 is a perspective assembly view of the level clip of FIG. 1, including the frame structure and the vial, wherein the vial is shown separated from the frame structure, according to the invention;

FIG. 3 is a perspective view of the level clip of FIG. 1 being secured to the edge of a relatively thick painter's board, according to the invention;

FIG. 4 is a perspective view of the level clip of FIG. 1 shown secured to the edge of the relatively thick painter's board, wherein the edge of the painter's board abuts a first contact surface of the level clip, according to the invention;

FIG. 5 is a side elevation view of the level clip of FIG. 1 shown secured to the edge of a the painter's board, wherein the edge abuts a contact surface of the . clip, according to the invention;

FIG. 6 is a side view of the level clip being secured to the edge of a thin poster sheet, according to the invention;

FIG. 7 is a perspective view of the level clip of FIG. 1 shown secured to the edge of the poster sheet, wherein the edge of the poster sheet abuts a second contact surface of the level clip, according to the invention;

FIG. 8 is a lower perspective view of the level clip of FIG. 1 according to the invention showing details of a first and second contact surface and an upper and lower surface.

### DETAILED DESCRIPTION OF THE PREFERRED EMBODIMENTS

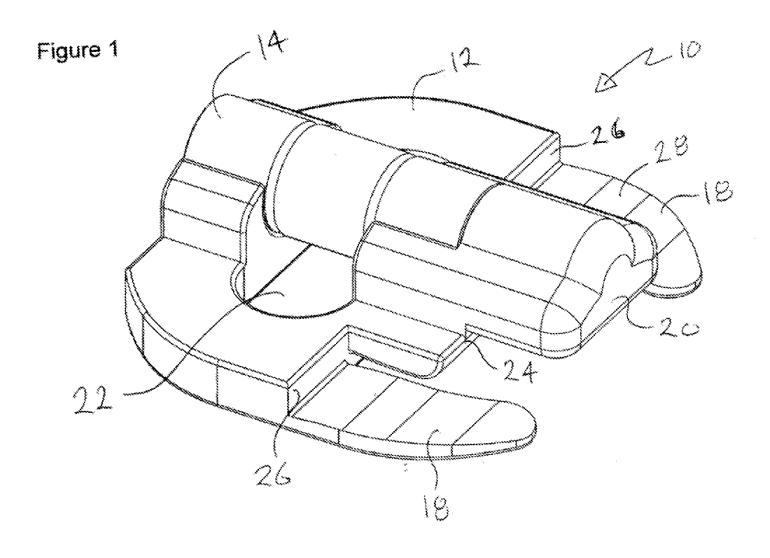

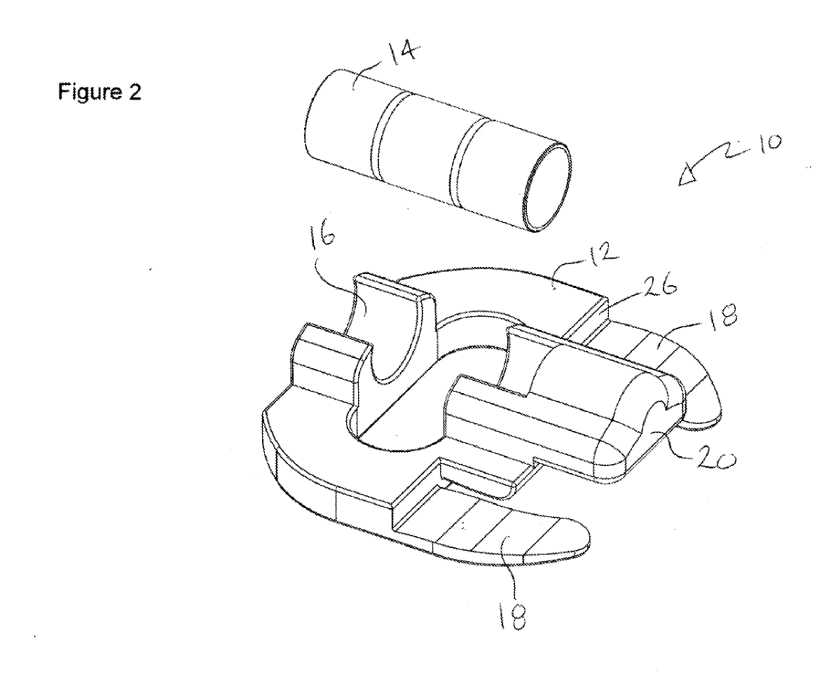

Referring to FIGS. 1 and 2, a level clip 10 according to the invention is shown having a frame structure 12 and a separate bubble vial 14. Frame structure 12 is preferably made as a single plastic injected molded part and includes a vial-receiving recess 16, two outer projecting arms 18, a central projection 20, and a light window 22, a first contact surface 24, for leveling thick substrates and a second contact surface 26, for leveling thin substrates, as explained below.

Vial 14 may be any conventional bubble vial of the type made from either clear plastic or glass that is cylindrical in shape and which defines a sealed cavity into which a controlled amount of colored viscous fluid is located. The amount of fluid sealed within the vial is such that a bubble of predetermined size is created. The inside surface of the cylindrical vial is longitudinally curved so that the bubble will move in a controlled manner along the top of the vial as the vial is tilted. Lines are typically printed on the outside of the cylinder to help the user determine when the bubble is centered, indicated a “level” condition. Although a cylindrically shaped vial is preferred for this invention, any shape may be used without departing from the gist of the invention.

Recess 16 of frame structure 12 is sized and shaped to snugly and firmly receive and hold vial 14. It is imperative for the present invention to work properly that vial 14 is held within recess 16 in such a manner to ensure that vial is held “true” with respect to first contact surface 24, and second contact surface 26 of frame structure 12.

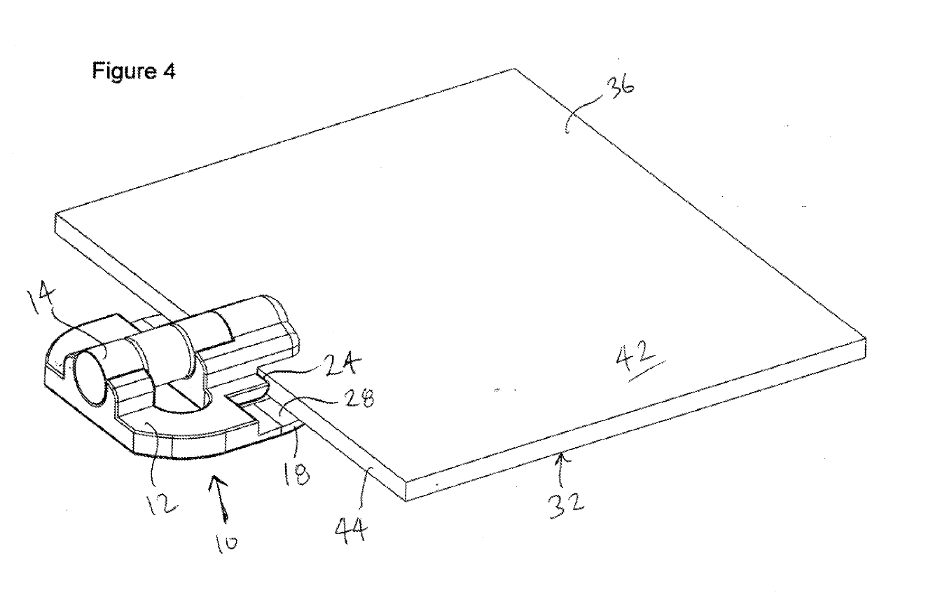

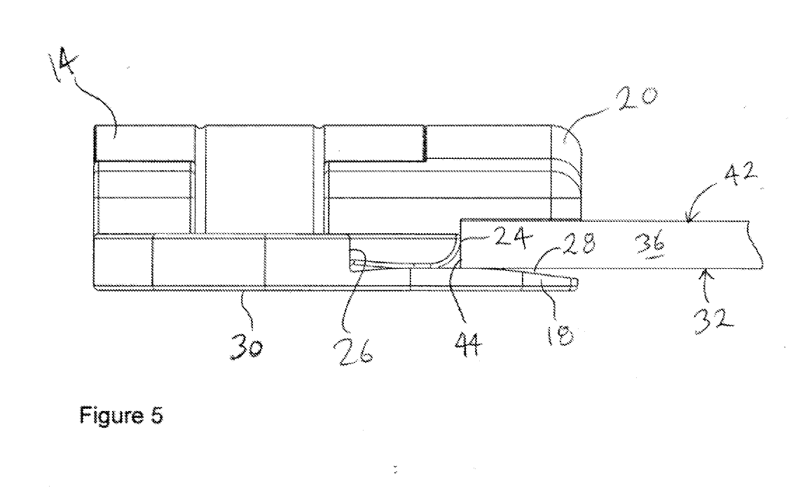

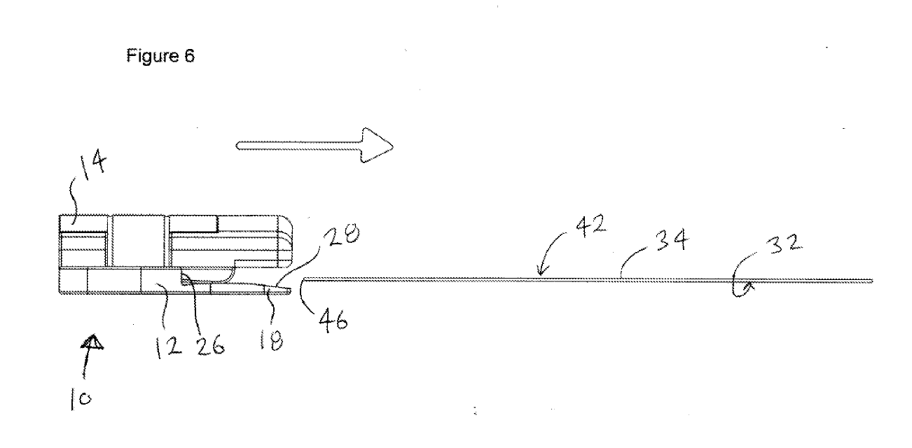

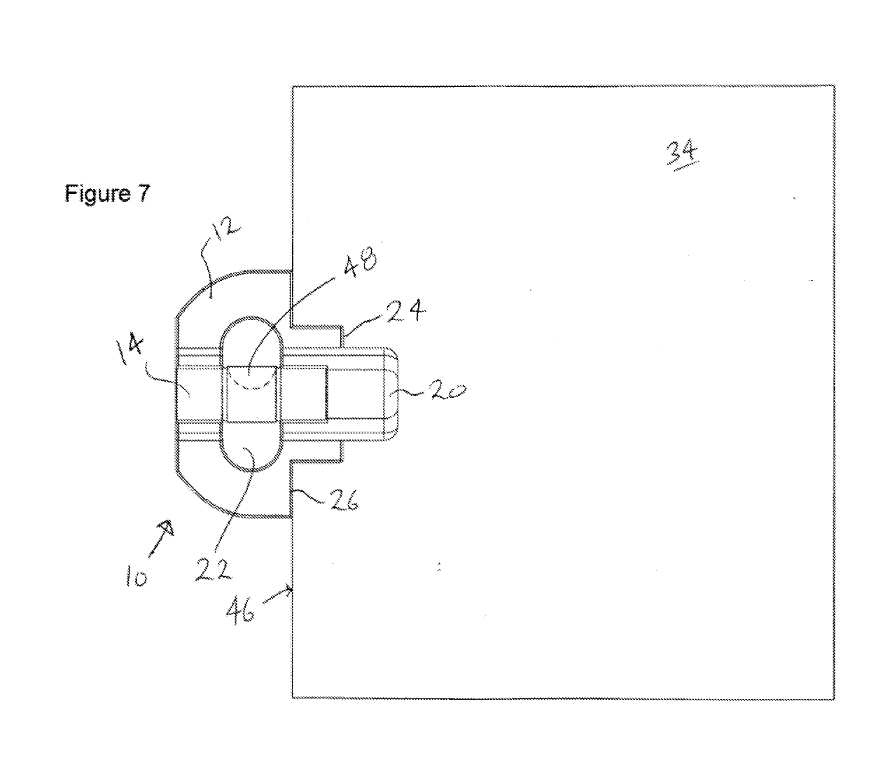

Outer arms 18 are integrally molded to frame structure 12 and include an upper surface 28 and a lower surface 30. Upper surface 28 is shaped and positioned to contact a rear surface 32 of either a thin substrate 34, as shown in FIGS. 6 and 7, or a thick substrate 36, as shown in FIGS. 4 and 5, when frame structure 12 is secured thereto, as described below.

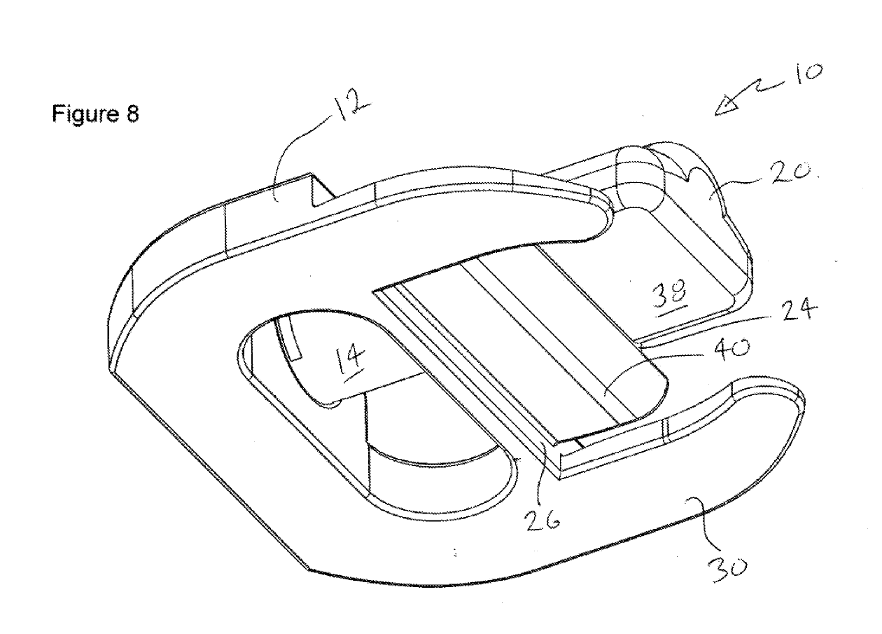

Referring to FIG. 8, central projection 20 includes a first lower surface 38 and a second lower surface 40. First lower surface 38 is sized and positioned to contact a front surface 42 of thick substrate 36, when frame structure 12 is secured thereto.

For Thicker Substrates (e.g., Painter's Board):

The distance between first lower surface 38 and upper surface 30 is slightly less than the thickness of thick substrate 36 so that when level clip 10 is secured to the edge of a thick substrate, such as a painter's board (which may vary in thickness, but is typically ⅛″ thick), central projection 20 and outer arms 18 work together and effectively clamp onto both respective surfaces of the thick substrate, thereby holding level clip 10 thereto. It is preferred that outer arms 18 be sized and shaped to provide a controlled amount of flex when level clip 10 is being secured to the edge of thick substrate 36. This flexure will help clamp the clip onto the substrate.

For Thinner Substrates (e.g., Poster Paper):

Thinner substrates (generally between 0.002 inches thick and 0.025 inches thick) are not as rigid as thicker boards and therefore may not be able to rely on the flexure of outer arms 18 to create the above described clamping action. To this end, second lower surface 40 is preferably located below upper surface 30 of outer arms 18 in a slightly overlapping relationship so that when level clip 10 is secured to the edge of a thin substrate, such as the edge of a poster, a paper template, or any other substrate that is relatively thin, such as paper, the thin substrate will deform about the overlapping second lower surface 40 and upper surface 30 of both outside arms 18. This deforming action creates friction which effectively holds level clip 10 firmly to the edge of the thin substrate. The amount of overlap will vary depending on the weight of level clip 10, the type of plastic the clip is molded from and the type of surface texture, if any located on the gripping surfaces (upper surface 30 and second lower surface 40), but Applicant has determined that an overlap less than 1 mm is sufficient to allow level clip 10 to hold firmly to a received thin substrate. Applicant has also recognized that when upper surface 30 and second lower surface 40 are coplanar, received thin substrates hold well.

Preferably integrally formed into central projection 20 is first contact surface 24. This contact surface is very important for the present invention to work accurately with thick substrates because this contact surface is what aligns vial 14 with the edge of the substrate. When this contact surface evenly abuts against the edge of the substrate, the substrate will become aligned with the level clip 10. Once aligned, the bubble located within vial 14 will accurately convey the orientation of the substrate and will indicate to the user when the substrate is level, with respect to “earth”.

Similarly, second contact surface 26 is integrally formed into frame structure 12 and it is very important for the present invention to work accurately with thin substrates because this contact surface is what aligns vial 14 with the edge of the substrate. When this contact surface evenly abuts against the edge of the substrate, the substrate will become aligned with the level clip 10. Once aligned, the bubble located within vial 14 will accurately convey the orientation of the substrate and will indicate to the user when the substrate is level, with respect to “earth”.

Light window 22 is preferably formed within frame structure 12 is used to allow ambient or directed light to more effectively illuminate the bubble located within vial 14.

In Use: For Thicker Substrates (e.g., Painter's Board):

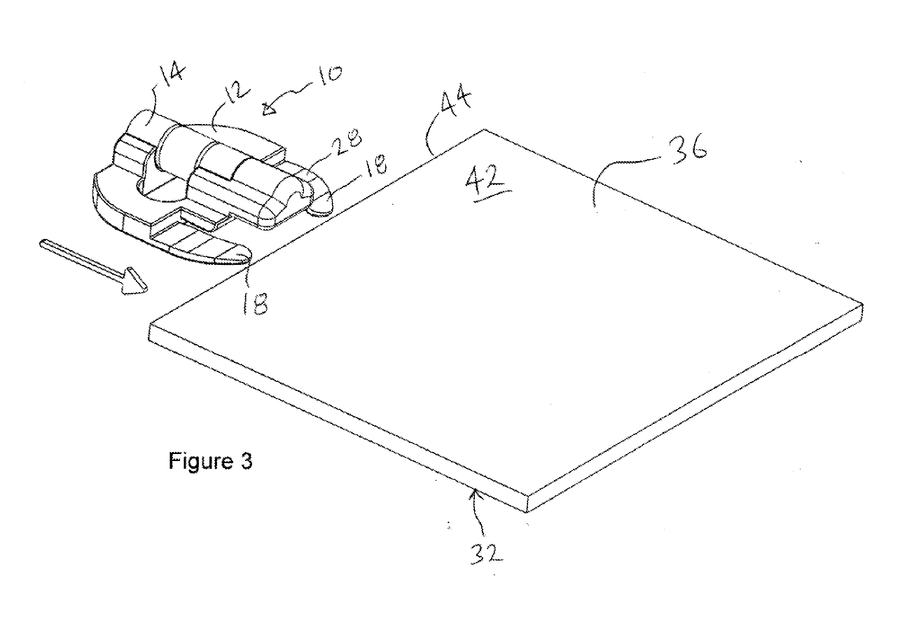

In use, referring to FIGS. 3 and 4, level clip 10 is shown being secured to the edge of a thick substrate 36, such as a painter's board. The user simply positions the level clip so that the edge of substrate 36 aligns between upper surface 30 of outer arms 18 and first lower surface 38 of central projection 20 and then advances the clip (see the arrow in FIG. 3) onto a vertically orientated edge 44 of the substrate. It is important that the user makes sure that the edge of the substrate abuts evenly with first contact surface 24. As explained above, the distance between these two surfaces is less than the thickness of substrate 36 so that as level clip 10 advances onto the substrate 36, outer arms 18 will flex away from central projection 20 and effectively create friction against the surfaces of substrate 36, thereby holding level clip in place. Once level clip 10 is properly clipped onto the edge of the thick substrate and the substrate edge evenly abuts against and fully contacts the first contact surface 24 of level clip 10, then the bubble located within vial 14 will convey the accurate orientation of the substrate during the hanging process. The user now can hold substrate 36 against a wall or other hanging surface and tilt the substrate clockwise and counter-clockwise until the bubble located in vial 14 registers a “level” condition. When this happens, the user applies any appropriate securing devices to affix substrate 36 to the wall so that the substrate remains in its level orientation.

In Use: For Thinner Substrates (e.g., Poster Paper):

In use, referring to FIGS. 5 and 6, level clip 10 is shown being secured to the edge of a thin substrate 34, such as a paper wall-poster. The user simply positions the level clip 10 so that the edge 46 of substrate 34 aligns between upper surface 30 of outer arms 18 and second lower surface 40 of central projection 20 and then advances the clip (in the direction of the arrow shown in FIG. 6) onto edge 46 of substrate 34. It is important that the user makes sure that edge 46 of substrate 34 eventually abuts evenly with second contact surface 26. As explained above, upper surface 28 of outer arms 18 and second lower surface 40 work together to create friction against the received paper substrate, thereby holding level clip 10 in place (similar to the holding action of a conventional paper clip. Once level clip 10 is properly clipped onto the edge 46 of the thin substrate and the substrate edge 46 evenly abuts against and fully contacts the second contact surface 26 of level clip 10, then the bubble 48 located within vial 14 will convey the accurate orientation of the substrate during the hanging process. The user now can hold substrate 34 against a wall or other hanging surface and tilt the substrate clockwise and counter-clockwise until bubble 48 located in vial 14 registers a “level” condition. When this happens, the user applies any appropriate securing devices to affix substrate 34 to the wall so that the substrate remains in its level orientation.

As shown in FIG. 4, frame structure 12 further includes a flat surface 50 opposite outer arms 18. This surface can be used to help level picture frames and other items having a thickness that is greater than poster board. In use, the user holds level clip 10 so that flat surface 50 evenly abuts against a vertical flat surface of the picture frame. This will “link” the bubble vial 14 of the level clip 10 with the frame so that the attitude of the frame against a wall may be accurately adjusted and a level orientation may be readily established.

One preferred version of level clip 10 is shown in the figures and described above in this specification. An important feature of this clip is that it can easily clip onto the edge of a substrate and this proves to be very useful to help level a poster or painter's board, or other similar item while hanging the item against a wall. The clip described above is meant to be attached to a vertical edge of a substrate, but the bubble vial could have also been secured to the frame structure in such a manner as to allow the clip to be attached along a horizontal edge of a substrate to allow the bubble level to operate in a horizontal orientation.

Also, other clipping structure could easily be used to clip the bubble vial to the edge of the substrate. Applicant disclosed in the present application a simple integral design wherein integrally formed arms work together to hold the clip and the bubble level to the edge of the substrate, but other structure could have been used without departing from the gist of the invention. This includes using spring-loaded pivotal components similar to the components and the resulting the action of a conventional spring-loaded clothes pin, or other conventional binder clip. Applicant prefers simplicity here.

Also, the above described outer arms 18 and first and second lower surfaces 38, 40 could have been positioned to accommodate substrates of different thicknesses. Applicant described a preferred example in the figures and above specification.

What is claimed is:

1. A level clip for securing onto the edge of a wall-hanging substrate for the purpose of leveling the substrate, said clip including:
a body having a substrate-receiving slot and a first contact surface;
a bubble level having a longitudinal axis and being secured to said body, said level being aligned with said first contact surface;
wherein said first contact surface is positioned within said slot for contacting said edge of said substrate and thereby allowing said bubble level to convey level-alignment information in response to movement of said substrate.

2. The level clip, according to claim 1, wherein said body includes a second contact surface and two projecting arms, said slot being defined as the space located between said second contacting surface and said two projecting arms.

3. The level clip, according to claim 2, wherein at least one of said two projecting arms includes a first gripping portion that extends within said slot, said gripping portion being sized to frictionally contact said substrate when said substrate is inserted within said slot so that said body becomes frictionally held to said inserted substrate.

4. The level clip, according to claim 2, wherein said body includes a second gripping portion that extends within said slot, said second gripping portion being sized to frictionally contact said substrate when said substrate is inserted within said slot so that said body becomes frictionally held to said inserted substrate.

5. The level clip, according to claim 1, wherein said bubble level is of the type that includes a vial having a cylindrical cavity which contains a predetermined volume of a fluid, said fluid volume is such that an air bubble is formed and freely moves within said cavity, said bubble movement within said cavity being in response to angular displacement of said body and an attached substrate so that a level condition of said substrate may be determined.

6. The level clip, according to claim 1, wherein said bubble level is secured to said body so that said longitudinal axis is perpendicular to said contact surface of said body.

7. The level clip, according to claim 1, wherein said bubble level is secured to said body so that said longitudinal axis is parallel to said contact surface of said body.

8. A level clip for securing onto the edge of a planar wall-hanging substrate for the purpose of leveling the substrate, said clip including:
a body having a substrate-receiving slot and a first contact surface;
a bubble level having a longitudinal axis and being secured to said body, said level being aligned with respect to said first contact surface;
wherein said first contact surface is positioned within said slot for contacting said edge of said substrate and thereby allowing said bubble level to convey level-alignment information with respect to said edge of said substrate and in response to angular movement of said substrate.
